(19) United States
(12) Patent Application Publication
(10) Pub. No.: US 2020/0142159 A1
(43) Pub. Date: May 7, 2020

(54) OPTICAL LENS

(71) Applicant: ABILITY ENTERPRISE CO., LTD., New Taipei City (TW)

(72) Inventors: Chia-Hung CHEN, New Taipei City (TW); Jui-Wen TENG, New Taipei City (TW)

(21) Appl. No.: 16/451,112

(22) Filed: Jun. 25, 2019

(30) Foreign Application Priority Data
Nov. 6, 2018 (TW) 107139378

(51) Int. Cl. G02B 13/00; G02B 9/34

(52) U.S. Cl. CPC G02B 13/004; G02B 9/34

(57) ABSTRACT

An optical lens, in order from an object side to an image-forming side, includes: a first lens having positive refractive power, a second lens having positive refractive power, a third lens having positive refractive power, and a fourth lens. The distance from an outer edge of the image-side surface of the fourth lens to an optical axis of the optical lens is H. The image-side surface of the fourth lens has an inflection point, and the distance from the inflection point to the optical axis is h. The image-side surface of the fourth lens and the optical axis intersect at an intersection point. The distance between a projected position of the inflection point on the optical axis and the intersection point is d0. The optical lens satisfies at least one of the following conditions: 0.6≤h/H, h/H≤0.95, 3.75≤H/d0 and H/d0≤30.

This application claims the benefit of Taiwan application Serial No. 107139378, filed Nov. 6, 2018, the subject matter of which is incorporated by reference herein in its entirety.

### TECHNICAL FIELD

The invention relates in general to an optical lens, and more particularly to an optical lens with compact volume and excellent imaging quality.

### BACKGROUND

In recent years, as the application of the image capturing devices has become more and more widespread, the demand for a compact optical lens has also increased. Besides, the requirement for the imaging quality of the optical lens in the market has become higher and higher as well. In order to be more competitive in the market, miniaturization, high quality and low cost have always been the goals for product development.

Therefore, it is in need to provide a novel optical lens to achieve an optical lens with miniaturized size and improved image quality at the same time in the condition of low manufacturing cost.

### SUMMARY

The invention is directed to an optical lens. In the condition of low manufacturing cost, the optical lens with miniaturized size and improved image quality at the same time is achieved.

According to one embodiment, an optical lens is provided. The optical lens, in order from an object side to an image-forming side, includes: a first lens having positive refractive power, a second lens having positive refractive power, a third lens having positive refractive power, and a fourth lens. The distance from an outer edge of an image-side surface of the fourth lens to an optical axis of the optical lens is H. The image-side surface of the fourth lens has an inflection point. The distance from the inflection point to the optical axis is h. The image-side surface of the fourth lens and the optical axis intersect at an intersection point. The distance between a projected position of the inflection point on the optical axis and the intersection point is d0. The optical lens satisfies at least one of the following conditions: 0.6≤h/H, h/H≤0.95, 3.75≤H/d0 and H/d≤30.

According to another embodiment, an optical lens is provided. The optical lens, in order from an object side to an image-forming side, includes: a first lens having positive refractive power, a second lens having refractive power, a third lens having positive refractive power, and a fourth lens having negative refractive power. The distance from an outer edge of an image-side surface of the fourth lens to an optical axis of the optical lens is H. The image-side surface of the fourth lens has an inflection point. The distance from the inflection point to the optical axis is h. The distance from an intersection point of the image-side surface of the fourth lens and the optical axis to a projected position of the inflection point on the optical axis is d0. The optical lens satisfies at least one of the following conditions: 0.6≤h/H, h/H≤0.95, 3.75≤H/d0 and H/d0≤30.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows an optical lens according to one embodiment of the present invention.

FIG. 2 shows an optical lens according to another embodiment of the present invention.

FIG. 3 shows an optical lens according to still another embodiment of the present invention.

FIG. 4A lists each lens parameter of the optical lens of FIG. 1 according to one embodiment of the present invention.

FIG. 4B lists aspheric coefficients of the mathematic equation of the aspheric lenses of the optical lens of FIG. 1 according to one embodiment of the present invention.

FIG. 5A lists each lens parameter of the optical lens of FIG. 2 according to another embodiment of the present invention.

FIG. 5B lists aspheric coefficients of the mathematic equation of the aspheric lenses of the optical lens of FIG. 2 according to another embodiment of the present invention.

FIG. 6A lists each lens parameter of the optical lens of FIG. 3 according to still another embodiment of the present invention.

FIG. 6B lists aspheric coefficients of the mathematic equation of the aspheric lenses of the optical lens of FIG. 3 according to still another embodiment of the present invention.

FIG. 7 lists optical information of the optical lenses of FIGS. 4A, 5A, and 6A.

### DETAILED DESCRIPTION

The embodiments of the present invention are described in details with reference to the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known components and process operations are not described in detail in order not to unnecessarily obscure the present invention. Identical or similar elements of the embodiments are designated with the same or similar reference numerals. While drawings are illustrated in details, it is appreciated that the quantity or sizes of the disclosed components may be greater or less than that disclosed, except expressly restricting the amount or the sizes of the components.

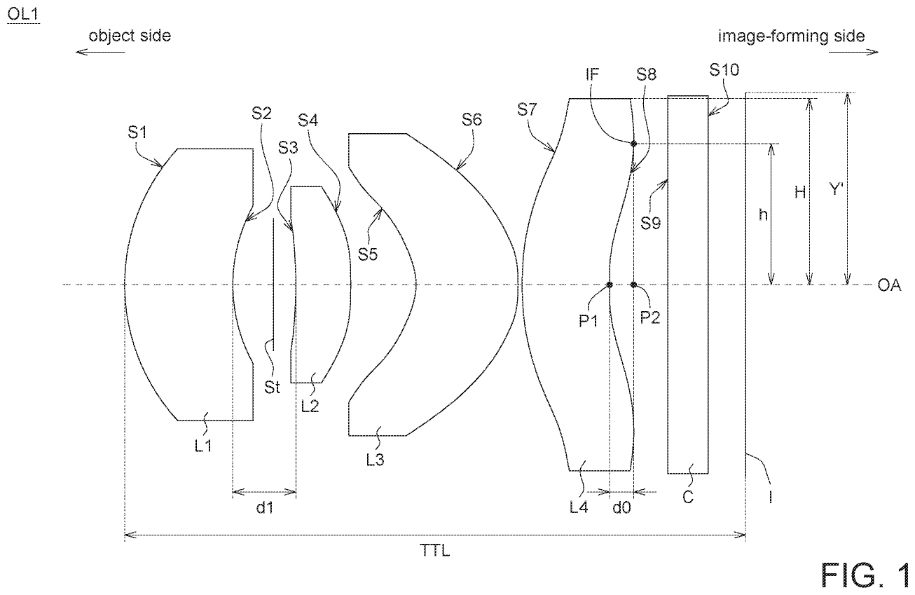

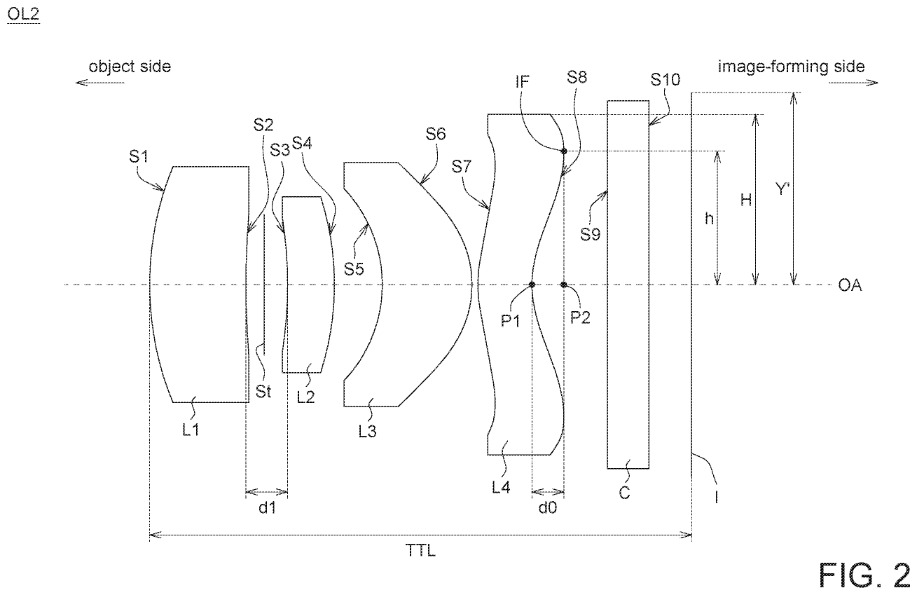

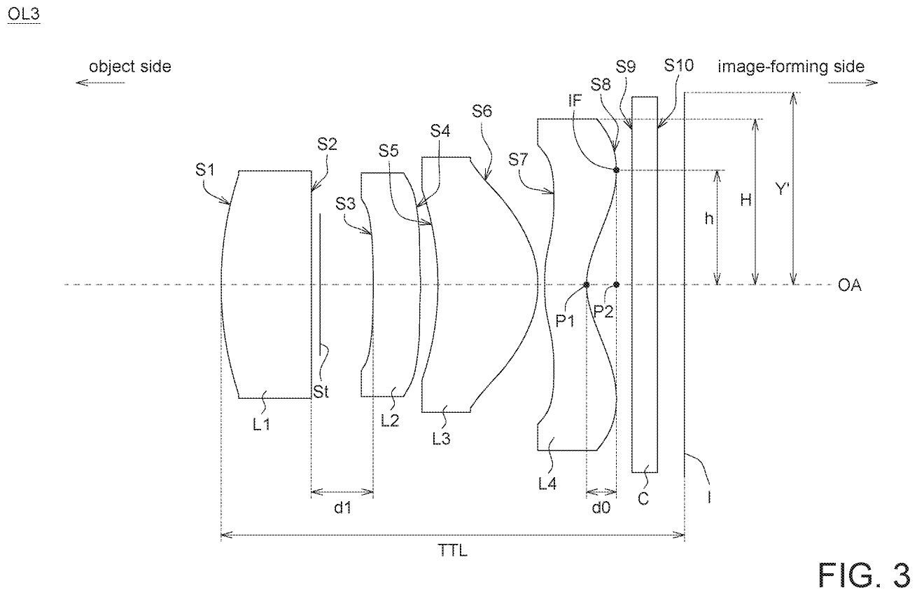

FIG. 1 shows an optical lens OL1 according to one embodiment of the present invention. FIG. 2 shows an optical lens OL2 according to another embodiment of the present invention. FIG. 3 shows an optical lens OL3 according to still another embodiment of the present invention. To show the features of the present embodiment, only the structure related to the present embodiment is shown, and the rest of the structure is omitted. The optical lenses OL1, OL2 and OL3 may be applied to a device capable of image projection or image capture, the device including but not limited to a handheld computer system, a handheld communication system, an aerial camera, a sports camera lens, a camera lens for vehicle, a surveillance system, a digital camera, a digital video camera or a projector.

Referring to FIG. 1, FIG. 2 and FIG. 3, the optical lenses OL1, OL2 and OL3, in order from an object side to an image-forming side, may include a first lens L1, a second lens L2, a third lens L3 and a fourth lens L4. The first lens L1, the second lens L2, the third lens L3 and the fourth lens L4 may be arranged along the optical axis OA.

In some embodiments, the first lens L1 may have positive refractive power the second lens L2 may have refractive power, such as positive refractive power and negative refractive power the third lens L3 may have positive refractive power, the fourth lens L4 may have refractive power, such as positive refractive power and negative refractive power.

In some embodiments, the first lens L1 may have positive refractive power, the second lens L2 may have positive refractive power, the third lens L3 may have positive refractive power, and the fourth lens L4 may have positive refractive power. In another embodiment, the first lens L1 may have positive refractive power, the second lens L2 may have positive refractive power, the third lens L3 may have positive refractive power, and the fourth lens L4 may have negative refractive power. In still another embodiment, the first lens L1 may have positive refractive power, the second lens L2 may have negative refractive power, the third lens L3 may have positive refractive power, and the fourth lens L4 may have negative refractive power. However, the present invention is not limited thereto.

In some embodiments, TTL is a distance from an object-side surface S1 of the first lens L1 to an imaging plane I, f is a focal length of the optical lenses OL1, OL2, OL3, and the optical lenses OL1, OL2, OL3 may satisfy at least one of the following conditions: 3.5 mm≤f, 3.9 mm≤f, f≤4.5 mm, f≤5 mm, 4.8 mm≤TTL, TTL≤7 mm, TTL≤8 mm, 1≤TTL/f, 1.2≤TTL/f, 1.4≤TTL/f, 1.47≤TTL/f, TTL/f≤2, TTL/f≤2.1 and TTL/f≤2.5.

In some embodiments, d1 is a distance between an image-side surface S2 of the first lens L1 and an object-side surface S3 of the second lens L2, and the optical lenses OL1, OL2, OL3 may satisfy at least one of the following conditions: 0.45 mm≤d1, 0.5 mm≤d1, d1≤0.8 mm, d1≤1 mm and d1≤1.2 mm.

In some embodiments, the optical lenses OL1, OL2, OL3 may satisfy at least one of the following conditions: 0.06≤d1/TTL, 0.08≤d1/TTL, d1/TTL≤0.12 and d1/TTL≤0.15.

In some embodiments, Y′ is an image height (half image sensor height) of the optical lenses OL1, OL2, OL3, and the optical lenses OL1, OL2, OL3 may satisfy at least one of the following conditions: 1≤f/Y′, 1.2≤f/Y′, 1.4≤f/Y′, 1.5≤f/Y′, 1.75≤f/Y′, f/Y′≤2, f/Y′≤2.3 and f/Y′≤2.5.

In some embodiments, FOV is a field of view of the optical lenses OL1, OL2, OL3, and the optical lenses OL1, OL2, OL3 may satisfy at least one of the following conditions: 30°≤FOV, 40°≤FOV, FOV≤70° and FOV≤80°.

In some embodiments, Fno is an aperture of the optical lenses OL1, OL2, OL3, and the optical lenses OL1, OL2, OL3 may satisfy at least one of the following conditions: 0.05≤(Fno×TTL)/(FOV×Y′), 0.07≤(Fno×TTL)/(FOV×Y′), (Fno×TTL)/(FOV×Y′)≤0.13, (Fno×TTL)/(FOV×Y′)≤0.17, (Fno×TTL)/(FOV×Y′)≤0.22, (Fno×TTL)/(FOV×Y′)≤0.25 and (Fno×TTL)/(FOV×Y′)≤0.3.

In some embodiments, R1 is a curvature radius of the object-side surface S1 of the first lens L1, R2 is a curvature radius of the image-side surface S2 of the first lens L1, and the optical lenses OL1, OL2, OL3 may satisfy at least one of the following conditions: −1.5≤(R1−R2)/(R1+R2), −1.2≤(R1−R2)/(R1+R2), −1≤(R1−R2)/(R1+R2), (R1−R2)/(R1+R2)≤0.1, (R1−R2)/(R1+R2)≤0.2 and (R1−R2)/(R1+R2)≤0.5.

In some embodiments, R3 is a curvature radius of an object-side surface S3 of the second lens L2, R4 is a curvature radius of an image-side surface S4 of the second lens L2, and the optical lenses OL1, OL2, OL3 may satisfy at least one of the following conditions: −1.3≤(R3−R4)/(R3+R4), −1≤(R3−R4)/(R3+R4), −0.8≤(R3−R4)/(R3+R4), (R3−R4)/(R3+R4)≤0.7, (R3−R4)/(R3+R4)≤1 and (R3−R4)/(R3+R4)≤1.2.

In some embodiments, R5 is a curvature radius of an object-side surface S5 of the third lens L3, R6 is a curvature radius of an image-side surface S6 of the third lens L3, and the optical lenses OL1, OL2, OL3 may satisfy at least one of the following conditions: −0.5≤(R5−R6)/(R5+R6), −0.25≤(R5−R6)/(R5+R6), 0≤(R5−R6)/(R5+R6), (R5−R6)/(R5+R6)≤0.6, (R5−R6)/(R5+R6)≤0.8 and (R5-R6)/(R5+R6)≤1.

In some embodiments, R7 is a curvature radius of an object-side surface S7 of the fourth lens L4, R8 is a curvature radius of an image-side surface S8 of the fourth lens L4, and the optical lenses OL1, OL2, OL3 may satisfy at least one of the following conditions: −0.5≤(R7−R8)/(R7+R8), −0.2≤(R7−R8)/(R7+R8), 0≤(R7−R8)/(R7+R8), (R7−R8)/(R7+R8)≤0.4, (R7−R8)/(R7+R8)≤0.75 and (R7−R8)/(R7+R8)≤1.

In some embodiments, the first lens L1 has a refractive index N1 and an Abbe number V1, the second lens L2 has a refractive index N2 and an Abbe number V2, the third lens L3 has a refractive index N3 and an Abbe number V3, the fourth lens L4 has a refractive index N4 and an Abbe number V4, and the optical lenses OL1, OL2, OL3 may satisfy at least one of the following conditions: N1>N2, N2>N3, N2>N4, V1>V2, V3>V2 and V4>V2.

Furthermore, in some embodiments, the optical lenses OL1, OL2, OL3 may satisfy at least one of the following conditions: N1−N2≥0.05, N2−N3≥0.05, N2−N4≥0.05, V1−V2≥5.0, V3−V2≥5.0 and V4−V2≥5.0.

In some embodiments, the first lens L1, the second lens 12, the third lens L3 and the fourth lens L4 may respectively be a spherical lens, a free-form lens or an aspheric lens.

Specifically, each of the free-form lenses has at least one free-form surface; that is, an object-side surface and/or an image-side surface of the free-form lens are/is the free-form surface(s). Each of the aspheric lenses has at least one aspheric surface; that is, an object-side surface and/or an image-side surface of the aspheric lens are/is the aspheric surface(s). And, each of the aspheric surfaces may satisfy the following mathematic equation:

$$Z = [ \frac{( C * {Y}^{2} )}{1 + \sqrt{1 - ( K + 1 ) {C}^{2} {Y}^{2}}} ] + Σ ( {A}_{i} * {Y}^{1} )$$

where Z is the coordinate in the optical axis OA direction, and the direction in which light propagates is designated as positive; A₄, A₆, A₈, A₁₀, A₁₂. A₁₄, and A₁₆ are aspheric coefficients; K is coefficient of quadratic surface; C is reciprocal of R (C=1/R); R is the radius of curvature; Y is the coordinate in a direction perpendicular to the optical axis OA, in which the upward direction away from the optical axis OA is designated as positive. In addition, each of the parameters or the coefficients of the equation of each of the aspheric lenses may be designated respectively to determine the focal length of each of the aspheric lenses.

In one specific embodiment, the first lens L1 may be a spherical lens, at least one of the second lens L2, the third lens L3 and the fourth lens L4 may be an aspheric lens, but the present invention is not limited thereto. In one specific embodiment, all of the second lens L2, the third lens L3 and the fourth lens L4 are aspheric lenses.

In some embodiments, the first lens L1, the second lens L2, the third lens L3 and the fourth lens L4 may respectively be a glass lens made of a glass material or a plastic lens made of a plastic material. The material of the plastic lens may include, but not limited to, polycarbonate, cyclic olefin copolymer (e.g. APEL), polyester resins (e.g. OKP4 or OKP4HT) and so on, or a mixture and/or a compound material including at least one of the above-mentioned three materials.

For example, the first lens L1 may be a glass lens, at least one of the second lens L2, the third lens L3 and the fourth lens L4 may be a plastic lens, but the present invention is not limited thereto.

Referring to FIG. 1 to FIG. 3, the object-side surface S1 of the first lens L1 may be a convex surface convex toward the object side, having positive refractive rate; the image-side surface S2 may be a concave surface concave toward the object side, having positive refractive rate. The first lens L1 may be a lens having positive refractive power, the lens including but not limited to any one of a convex-concave lens, glass or plastic lens, and a spherical or aspheric lens having positive refractive power, or a combination thereof.

The object-side surface S3 of the second lens L2 may be a concave surface concave toward the image-forming side, having negative refractive rate; the image-side surface S4 may be a convex surface convex toward the image-forming side, having negative refractive rate. The second lens L2 may be a lens having refractive power, the lens including but not limited to any one of a concave-convex lens, glass or plastic lens, and a spherical or aspheric lens having positive refractive power or negative refractive power, or a combination thereof.

The object-side surface S5 of the third lens L3 may be a concave surface concave toward the image-forming side, having negative refractive rate; the image-side surface S6 may be a convex surface convex toward the image-forming side, having negative refractive rate. The third lens L3 may be a lens having positive refractive power, the lens including but not limited to any one of a concave-convex lens, glass or plastic lens, and a spherical or aspheric lens having positive refractive power, or a combination thereof.

The object-side surface S7 of the fourth lens L4 may be a convex surface convex toward the object side, having positive refractive rate; the image-side surface S8 may form a convex surface convex toward the image-forming side at a location far away from the optical axis OA, and form a concave surface concave toward the object side at a location close to the optical axis OA. The image-side surface S8 has positive refractive rate at the optical axis OA. The fourth lens L4 may be a lens having refractive power, the lens including but not limited to any one of a lens, glass or plastic lens, and a spherical or aspheric lens having positive refractive power or negative refractive power, or a combination thereof.

In some embodiments, the image-side surface S8 of the fourth lens L4 of the optical lenses OL1, OL2, OL3 is an aspheric surface, and the image-side surface S8 has an inflection point IF. A distance from the inflection point IF to the optical axis OA is h, h including but not limited to the shortest distance or the vertical distance from the inflection point IF to the optical axis OA. The optical lenses OL1, OL2, OL3 may satisfy at least one of the following conditions: 1 mm≤h, 1.3 mm≤h, 1.6 mm≤h, h≤1.9 mm, h≤2 mm and h≤2.2 mm.

In some embodiments, a distance from an outer edge of the image-side surface S8 of the fourth lens L4 to the optical axis OA is H, H including but not limited to the radius of the optical effective diameter of the image-side surface S8, the radius of the effective diameter of the fourth lens L4, the shortest distance or the vertical distance from the optical effective diameter of the image-side surface S8 to the optical axis OA. The optical lenses OL1, OL2, OL3 may satisfy at least one of the following conditions: 1.5 mm≤H, 1.7 mm≤H, 2 mm≤H, H≤2.4 mm, H≤2.7 mm and H≤3 mm.

In some embodiments, the image-side surface S8 of the fourth lens L4 and the optical axis OA intersect at an intersection point P1. The inflection point IF is projected on the optical axis OA at a projected position P2. The distance between the intersection point P1 and the projected position P2 is d0. The optical lenses OL1, OL2, OL3 may satisfy at least one of the following conditions: 0.25 mm≤d0, 0.27 mm≤d0, 0.3 mm≤d0, d0≤0.37 mm and d0≤0.4 mm.

In other embodiments, the optical lenses OL1, OL2, OL3 may satisfy at least one of the following conditions: 0.6≤h/H, 0.67≤h/H, h/H≤0.9 and h/H≤0.95.

In still other embodiments, the optical lenses OL1, OL2, OL3 may satisfy at least one of the following conditions: 3.75≤H/d0, 5≤H/d0, H/d0≤8, H/d0≤12, H/d0≤15, H/d0≤25 and H/d0≤30.

Moreover, referring to FIG. 1 to FIG. 3, other differences among the optical lenses OL1, OL2 and OL3 are in that: the second lens L2 and the fourth lens L4 of the optical lens OL1 both have positive refractive power; the second lens L2 of the optical lens OL2 has positive refractive power, while the fourth lens L4 has negative refractive power; the second lens L2 and the fourth lens L4 of the optical lens OL3 both have negative refractive power.

In some embodiments, the optical lenses OL1, OL2, OL3 may further include a stop St and/or a protection plate C. Furthermore, an image capturing unit (not shown) may be further disposed on the imaging plane I for photo-electrically converting light beams passing through the optical lenses OL1, OL2, OL3. The stop St may be arranged on the object side of the first lens L1, in any intervals between any two of the first lens L1 to the fourth lens L4, or between the fourth lens L4 and the imaging plane I. In one specific embodiment, the stop St is arranged between the first lens L1 and the second lens L2, but the present invention is not limited thereto. The protection plate C may be arranged between the fourth lens L4 and the imaging plane I, and a filter film (not shown) may further be formed on the protection plate C.

In one embodiment, the optical lenses OL1, OL2, OL3 may further include a filter plate (not shown), which may be arranged between the fourth lens L4 and the protection plate C. In another embodiment, the functions of protecting the image capturing unit and filtering the infrared light may both be integrated into the protection plate C.

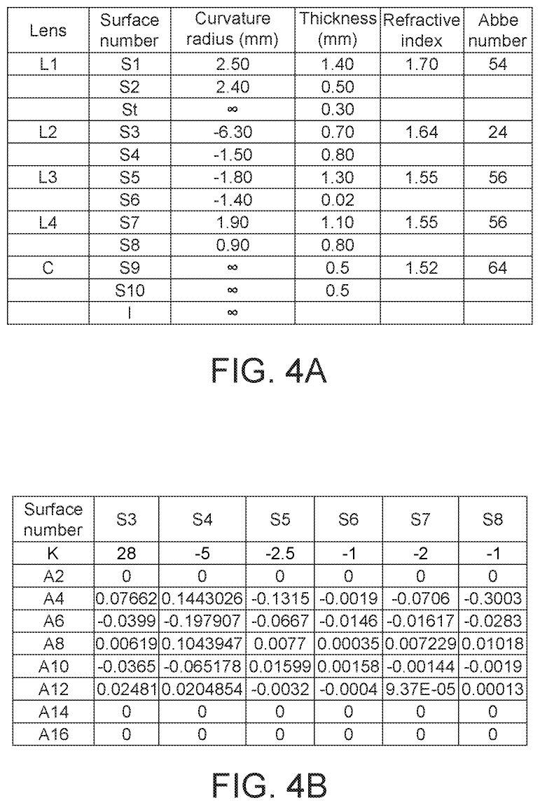

FIG. 4A lists each lens parameter of the optical lens OL1 of FIG. 1 according to one embodiment of the present invention, including the curvature radius, the thickness, the refractive index, the Abbe number (coefficient of chromatic dispersion), and so on of each of the lenses. The surface numbers of the lenses are sequentially ordered from the object side to the image-forming side. For example, “St” stands for the stop St, “S1” stands for the object-side surface S1 of the first lens L1, “S2” stands for the image-side surface S2 of the first lens L1, . . . , “S9” and “S10” respectively stand for the object-side surface S9 and the image-side surface S10 of the protection plate C, and so on. In addition, the “thickness” stands for the distance between an indicated surface and an adjacent surface close to the image-forming side. For example, the “thickness” of the object-side surface S1 is the distance between the object-side surface S1 of the first lens L1 and the image-side surface S2 of the first lens L1; the “thickness” of the image-side surface S2 is the distance between the image-side surface S2 of the first lens L1 and the object-side surface S3 of the second lens L2.

FIG. 4B lists aspheric coefficients of the mathematic equation of the aspheric lenses of the optical lens OL1 of FIG. 1 according to one embodiment 1. of the present invention. If the object-side surfaces S3, S5, S7 and the image-side surfaces S4, S6, S8 of the second lens L2, the third lens L3 and the fourth lens L4 of the optical lens OL1 are aspheric surfaces, each of the aspheric coefficients for the mathematic equation of the aspheric lenses may be listed as indicated in FIG. 4B.

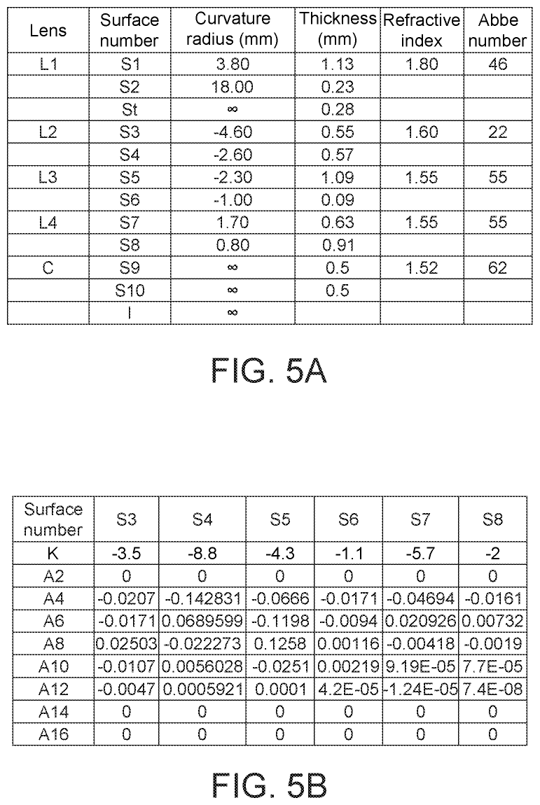

FIG. 5A lists each lens parameter of the optical lens OL2 of FIG. 2 according to another embodiment of the present invention, the definitions and meanings of which are substantially the same as those of FIG. 4A.

FIG. 5B lists aspheric coefficients of the mathematic equation of the aspheric lenses of the optical lens OL2 of FIG. 2 according to another embodiment of the present invention. If the object-side surfaces S3, S5, S7 and the image-side surfaces S4, S6, S8 of the second lens L2, the third lens L3 and the fourth lens L4 of the optical lens OL2 are aspheric surfaces, each of the aspheric coefficients for the mathematic equation of the aspheric lenses may be listed as indicated in FIG. 5B.

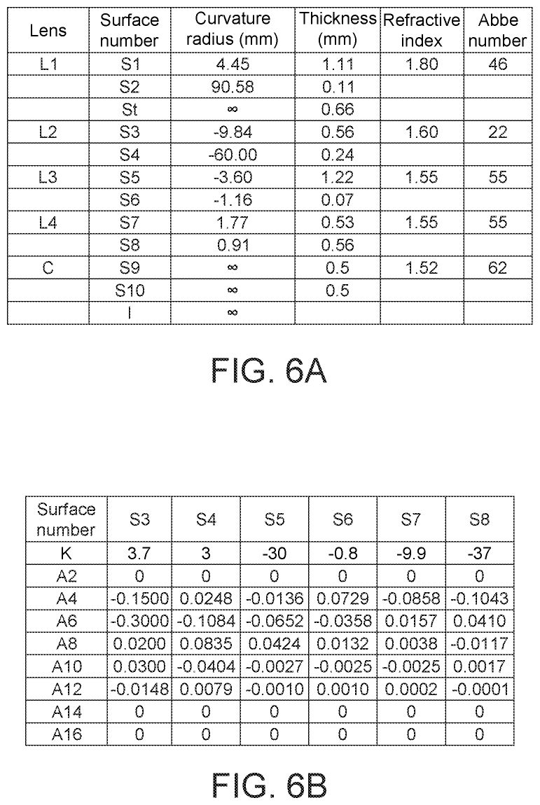

FIG. 6A lists each lens parameter of the optical lens OL3 of FIG. 3 according to still another embodiment of the present invention, the definitions and meanings of which are substantially the same as those of FIG. 5A.

FIG. 6B lists aspheric coefficients of the mathematic equation of the aspheric lenses of the optical lens OL3 of FIG. 3 according to still another embodiment of the present invention. If the object-side surfaces S3, S5, S7 and the image-side surfaces S4, S6, S8 of the second lens L2, the third lens L3 and the fourth lens L4 of the optical lens OL3 are aspheric surfaces, each of the aspheric coefficients for the mathematic equation of the aspheric lenses may be listed as indicated in FIG. 6B.

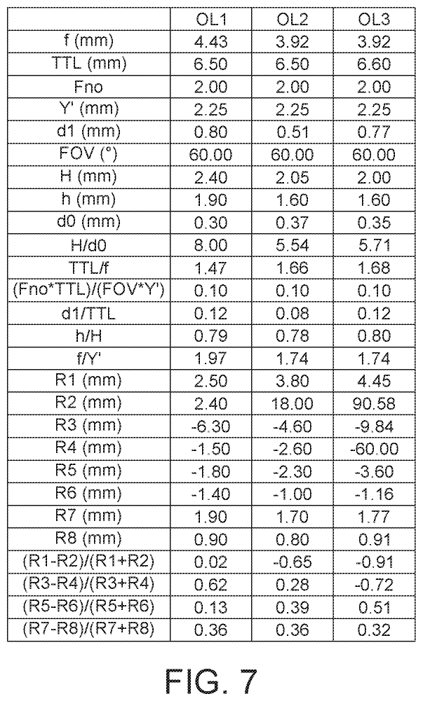

FIG. 7 lists optical information of the optical lenses OL1, OL2, OL3 of FIGS. 4A, 5A, and 6A, including the focal length f, the distance TTL from the object-side surface S1 of the first lens L1 to the imaging plane I, the aperture Fno, the image height Y′, the distance d1 from the intersection point of the image-side surface S2 of the first lens L1 and optical axis OA to the intersection point of the object-side surface S3 of the second lens L2 and the optical axis OA, the field of view FOV, the distance H from the outer edge of the image-side surface S8 of the fourth lens L4 to the optical axis OA, the distance h from the inflection point IF of the fourth lens L4 to the optical axis OA, the distance d0 from the intersection point of the image-side surface S8 of the fourth lens L4 and the optical axis OA to the projected position of the inflection point IF on the optical axis OA, the curvature radii R1-R8 of each lens surface of the first lens L1 to the fourth lens L4, and the values of the relations for the above parameters.

From the above embodiments, the optical lenses OL1, OL2, OL3 may feature in both miniaturized size and improved image quality at the same time in the condition of low manufacturing cost.

It will be apparent to those skilled in the art that various modifications and variations can be made to the disclosed embodiments. It is intended that the specification and examples be considered as exemplary only, with a true scope of the invention being indicated by the following claims and their equivalents.

What is claimed is:

1. An optical lens having an optical axis, the optical lens, in order from an object side to an image-forming side, comprising:
a first lens having positive refractive power;
a second lens having positive refractive power;
a third lens having positive refractive power; and
a fourth lens having an image-side surface with a inflection point, the image-side surface of the fourth lens and the optical axis intersect at an intersection point, and the optical lens satisfies at least one of the following conditions: 0.6≤h/H, h/H≤0.95, 3.75≤H/d0 and H/d≤30, wherein H is a distance from an outer edge of the image-side surface of the fourth lens to the optical axis, h is a distance from the inflection point to the optical axis and d0 is a distance between a projected position of the inflection point on the optical axis and the intersection point.

2. The optical lens according to claim 1, wherein f is a focal length of the optical lens, Y′ is an image height of the optical lens, d1 is a distance between an image-side surface of the first lens and an object-side surface of the second lens, TTL is a distance from an object-side surface of the first lens to an imaging plane, and the optical lens further satisfies at least one of the following conditions: 3.5 mm≤f, f≤5 mm, 1≤f/Y′, f/Y′≤2.5, 1≤TTL/f, TTL/f≤2.5, 0.45 mm≤d1, d1 mm≤1.2, 4.8 mm≤TTL, TTL≤8 mm, 0.06≤d1/TTL and d1/TTL≤0.15.

3. The optical lens according to claim 1, wherein FOV is a field of view of the optical lens, Fno is an aperture of the optical lens, Y′ is an image height of the optical lens, TTL is a distance from an object-side surface of the first lens to an imaging plane, and the optical lens further satisfies at least one of the following conditions: 30°≤FOV, FOV≤80°, 0.05≤(Fno×TTL)/(FOV×Y′) and (Fno×TTL)/(FOV×Y′)≤0.3.

4. The optical lens according to claim 1, wherein the optical lens further satisfies at least one of the following conditions: 1 mm≤h, h≤2.2 mm, 1.5 mm≤H, H≤3 mm, 0.25 mm≤d0 and d0≤0.4 mm.

5. The optical lens according to claim 1, wherein R1 is a curvature radius of an object-side surface of the first lens, R2 is a curvature radius of an image-side surface of the first lens, R3 is a curvature radius of an object-side surface of the second lens, R4 is a curvature radius of an image-side surface of the second lens, R5 is a curvature radius of an object-side surface of the third lens, R6 is a curvature radius of an image-side surface of the third lens, R7 is a curvature radius of an object-side surface of the fourth lens, R8 is a curvature radius of the image-side surface of the fourth lens, and the optical lens further satisfies at least one of the following conditions: −1.5≤(R1−R2)/(R1+R2), (R1−R2)/(R1+R2)≤0.5, −1.3≤(R3−R4)/(R3+R4), (R3−R4)/(R3+R4)≤1.2, −0.5≤(R5−R6)/(R5+R6), (R5−R6)/(R5+R6)≤1, −0.5≤(R7−R8)/(R7+R8) and (R7−R8)/(R7+R8)≤1.

6. The optical lens according to claim 1, wherein the first lens has a refractive index N1 and an Abbe number V1, the second lens has a refractive index N2 and an Abbe number V2, the third lens has a refractive index N3 and an Abbe number V3, the fourth lens has a refractive index N4 and an Abbe number V4, and the optical lens further satisfies at least one of the following conditions: N1>N2, N2>N3, N2>N4, V1>V2, V3>V2 and V4>V2.

7. An optical lens, in order from an object side to an image-forming side, comprising:
a first lens having positive refractive power;
a second lens having refractive power;
a third lens having positive refractive power; and
a fourth lens having negative refractive power, the image-side surface of the fourth lens has an inflection point, and the optical lens satisfies at least one of the following conditions: 0.6≤h/H, h/H≤0.95, 3.75≤H/d0 and H/d0530, wherein H is a distance from an outer edge of an image-side surface of the fourth lens to an optical axis of the optical lens, h is a distance from the inflection point to the optical axis and d0 is a distance from an intersection point of the image-side surface of the fourth lens and the optical axis to a projected position of the inflection point on the optical axis.

8. The optical lens according to claim 7, wherein d1 is a distance between an image-side surface of the first lens and an object-side surface of the second lens, TTL is a distance from an object-side surface of the first lens to an imaging plane, and the optical lens further satisfies at least one of the following conditions: 0.45 mm≤d1, d1 mm≤1.2, 4.8 mm≤TTL, TTL≤8 mm, 0.06≤d1/TTL and d1/TTL≤0.15.

9. The optical lens according to claim 7, wherein FOV is a field of view of the optical lens, Fno is an aperture of the optical lens, Y′ is an image height of the optical lens, f is a focal length of the optical lens, TTL is a distance from an object-side surface of the first lens to an imaging plane, and the optical lens further satisfies at least one of the following conditions: 30°≤FOV, FOV≤80°, 3.5 mm≤f, f≤5 mm, 1≤TTL/f, TTL/f≤2.5, 0.05≤(Fno×TTL)/(FOV×Y′), (Fno×TTL)/(FOV×Y′)≤0.3, 1≤f/Y′ and f/Y′≤2.5.

10. The optical lens according to claim 7, wherein the optical lens further satisfies at least one of the following conditions: 1 mm≤h, h≤2.2 mm, 1.5 mm≤H, H≤3 mm, 0.25 mm≤d0 and d0≤0.4 mm.

11. The optical lens according to claim 7, wherein R1 is a curvature radius of an object-side surface of the first lens, R2 is a curvature radius of an image-side surface of the first lens, R3 is a curvature radius of an object-side surface of the second lens, R4 is a curvature radius of an image-side surface of the second lens, R5 is a curvature radius of an object-side surface of the third lens, R6 is a curvature radius of an image-side surface of the third lens, R7 is a curvature radius of an object-side surface of the fourth lens, R8 is a curvature radius of the image-side surface of the fourth lens, and the optical lens further satisfies at least one of the following conditions: −1.5≤(R1−R2)/(R1+R2), (R1−R2)/(R1+R2)≤0.5, −1.3≤(R3−R4)/(R3+R4), (R3−R4)/(R3+R4)≤1.2, −0.5≤(R5−R6)/(R5+R6), (R5−R6)/(R5+R6)≤1, −0.5≤(R7−R8)/(R7+R8) and (R7−R8)/(R7+R8)≤1.

12. The optical lens according to claim 7, wherein the first lens has a refractive index N1 and an Abbe number V1, the second lens has a refractive index N2 and an Abbe number V2, the third lens has a refractive index N3 and an Abbe number V3, the fourth lens has a refractive index N4 and an Abbe number V4, and the optical lens further satisfies at least one of the following conditions: N1>N2, N2>N3, N2>N4, V1>V2, V3>V2 and V4>V2.

13. The optical lens according to claim 7, wherein the second lens has positive refractive power.

14. An optical lens, in order from an object side to an image-forming side, comprising:
a first lens having positive refractive power;
a second lens having a concave object-side surface and a convex image-side surface;
a third lens having positive refractive power; and
a fourth lens, the image-side surface of the fourth lens has an inflection point, the image-side surface of the fourth lens and the optical axis intersect at an intersection point, and the optical lens satisfies at least one of the following conditions: 0.6≤h/H, h/H≤0.95, 3.75≤H/d0 and H/d0≤30, wherein H is a distance from an outer edge of an image-side surface of the fourth lens to an optical axis of the optical lens, h is a distance from the inflection point to the optical axis and d0 is a distance between a projected position of the inflection point on the optical axis and the intersection point.

15. The optical lens according to claim 14, wherein the optical lens further satisfies at least one of the following conditions: 1 mm≤h, h≤2.2 mm, 1.5 mm≤H, H≤3 mm, 0.25 mm≤d0 and d0≤0.4 mm.

16. The optical lens according to claim 14, wherein f is a focal length of the optical lens, Y′ is an image height of the optical lens, d1 is a distance between an image-side surface of the first lens and the object-side surface of the second lens, TTL is a distance from an object-side surface of the first lens to an imaging plane, and the optical lens further satisfies at least one of the following conditions: 3.5 mm≤f, f≤5 mm, 1≤f/Y′, f/Y′≤2.5, 1≤TTL/f, TTL/f≤2.5, 0.45 mm≤d1, d1 mm≤1.2, 4.8 mm≤TTL, TTL≤8 mm, 0.06≤d1/TTL and d1/TTL≤0.15.

17. The optical lens according to claim 14, wherein FOV is a field of view of the optical lens, Fno is an aperture of the optical lens, Y′ is an image height of the optical lens, TTL is a distance from an object-side surface of the first lens to an imaging plane, and the optical lens further satisfies at least one of the following conditions: 30°≤FOV, FOV≤80°, 0.05≤(Fno×TTL)/(FOV×Y′) and (Fno×TTL)/(FOV×Y′)≤0.3.

18. The optical lens according to claim 14, wherein R1 is a curvature radius of an object-side surface of the first lens, R2 is a curvature radius of an image-side surface of the first lens, R3 is a curvature radius of the object-side surface of the second lens, R4 is a curvature radius of the image-side surface of the second lens, R5 is a curvature radius of an object-side surface of the third lens, R6 is a curvature radius of an image-side surface of the third lens, R7 is a curvature radius of an object-side surface of the fourth lens, R8 is a curvature radius of the image-side surface of the fourth lens, and the optical lens further satisfies at least one of the following conditions: −1.5≤(R1−R2)/(R1+R2), (R1−R2)/(R1+R2)≤0.5, −1.3≤(R3−R4)/(R3+R4), (R3−R4)/(R3+R4)≤1.2, −0.5≤(R5−R6)/(R5+R6), (R5−R6)/(R5+R6)≤1, −0.5≤(R7−R8)/(R7+R8) and (R7−R8)/(R7+R8)≤1.

19. The optical lens according to claim 14, wherein the first lens has a refractive index N1 and an Abbe number V1, the second lens has a refractive index N2 and an Abbe number V2, the third lens has a refractive index N3 and an Abbe number V3, the fourth lens has a refractive index N4 and an Abbe number V4, and the optical lens further satisfies at least one of the following conditions: N1>N2, N2>N3, N2>N4, V1>V2, V3>V2 and V4>V2.

20. The optical lens according to claim 14, wherein the optical lens further satisfies at least one of the following conditions: the second lens has positive refractive power and the fourth lens has negative refractive power.
